(19) United States
(12) Patent Application Publication
(10) Pub. No.: US 2009/0148957 A1
(43) Pub. Date: Jun. 11, 2009

(54) Platelet-free analyte assay method

(76) Inventor: Ajay Gupta, Cerritos, CA (US)

Correspondence Address: Kent Barta S.C., 2901 Jonathan Cir., Fitchburg, WI, 53711, US

(21) Appl. No.: 12/001,738

(22) Filed: Dec. 11, 2007

(51) Int. Cl. G01N 1/18

(52) U.S. Cl. 436/178

(57) ABSTRACT

A novel use of serum fractionation centrifuge tubes involves placing a plasma sample in the device and centrifuging at low speed. Platelet-free plasma flows from an outer tube through a plasma permeable filter membrane and collects in the inner tube of the device. This method results in higher platelet clearance than conventional methods because it screens out platelet fragments and minimizes platelet damage.

### CROSS REFERENCE TO RELATED APPLICATION

Applicant claims priority from a provisional application filed Dec. 12, 2006 having the same title.

### BACKGROUND OF THE INVENTION

In the animal body there are many cellular functions mediated by interaction of cells with specialized extracellular substances present in circulating blood. Many of these substances or analytes exist in two states, bound or unbound. Often the unbound or free substance is key to regulation of cellular processes, and the bound species is essentially inert. Such bound species may serve as a reservoir to replenish depleted levels of these substances or may be a source of elevated or depressed levels of free species in pathologic conditions. Hence, measurement of the level of free analyte has important diagnostic value.

A significant challenge in the measurement of free analyte is elimination of bound or other sources of inert or inactive analyte in a sample which artificially elevate the assayed values. For example, the presence of platelets in a sample may give such distorted values since platelets are known carriers of a wide variety of physiologically active substances. Platelets also synthesize a significant number of such substances which are retained in the platelet body and do not contribute to the free form in plasma which is the object of measurement. While a few novel approaches to platelet clearance have been reported, e.g. gel filtration (Tanquen, et al., Thromb. Diath. Haemorrh, 25: 268 (1971), the most prevalent method is centrifugation. In the literature there is a wide variety of centrifugation protocols described and the term “platelet-free” is variously defined. NCCLS document H21-A4 “Collection, Transport, and Processing of Blood Specimens for Testing Plasma-Based Coagulation Assays; 4^{th} ed. refers to “platelet-free” solutions obtained by subjecting plasma to two successive centrifugations at only 1500×g. Shet, et al., Blood: 102:2678 (2003) recommends a 13,000×g centrifugation. Several protocols teach a two stage 2500×g centrifugation (i.e. Quantitative Human Rantes Immunoassay Workshop Argentina 2006). Andre van der Ven, et al., Psychosomatic Med., 65: 194 (2003) describes a platelet-free plasma prepared by a 4500×g centrifugation.

Some platelet separation protocols specify high centrifugation speeds. The Iowa General Clinical Research Center has adopted a two stage 10,000×g method for clearing platelets. Ryan, et al. (Arthritis and Rheumatism, 22: 886 (1979) requires a 45,000×g ultracentrifugation step to reduce platelet sources of pyrophosphate to sufficiently low background levels. Very few clinical laboratories have centrifuges with high speed capability.

From the foregoing, it is apparent that “platelet-free” is a relative term, and means generally that degree of platelet removal that reduces interference to tolerable background levels for the particular analyte assay desired. Some assays are more tolerant than others, so lower speed centrifugation is sufficient. Some platelet contamination is to be expected even in high speed centrifugation because the platelet pellet is easily disturbed upon decanting and the centrifugation process itself can disrupt and fragment platelets. There is thus a basic need for a standard method of platelet clearance that can operate with standard clinical laboratory equipment and minimize manipulative damage to platelets.

### SUMMARY OF THE INVENTION

The method of the present invention involves a new use of conventional laboratory apparatus. It is an object of the invention to obtain a very high degree of platelet clearance in a test plasma sample, without the need for high speed centrifugation. It is a further object to separate platelets by exclusion means which minimize platelet disruption and fragmentation. It is a still further object to standardize platelet clearance so that the resulting plasma can be used to test all manner of analyte without adjusting experimental parameters.

According to the method for preparing a plasma specimen for assay of target analytes, a quantity of a plasma test sample containing an analyte of interest is introduced into a centrifuge apparatus of a certain type. The apparatus has an inner substantially cylindrical tube with a bottom portion and an open type, and an outer cylindrical tube. The inner tube fits snugly into the outer tube, but with sufficient space between them so that the inner tube can move freely within the outer tube. The apparatus is further characterized in having an analyte permeable membrane disposed between the inner and out tube, mounted in the inner tube bottom portion. The analyte permeable membrane may be mounted in a membrane housing, affixed directly to the bottom edges of the cylindrical inner tube to form a substantially flat surface perpendicular to the vertical axis of the tube. The outer tube is partially filled with the plasma, and the inner tube is inserted and air evacuated to bring the bottom portion in contact with the liquid plasma.

The plasma sample in the centrifuge apparatus is then subjected to low speed centrifugation to urge the inner tube downward into the outer tube, thereby separating platelet-free analyte containing analyte and other plasma components in the inner tube. Plasma-free plasma containing the analyte is then removed for assay The method of the invention is particularly efficacious where the analyte of interest is present in plasma as a free substance and also bound to or contained in the platelets. Such include, but are not limited to, sphiningosine-1-phosphate, blood clotting factors, matrix metalloproteinase-2, nitric oxide, angiopoietin-2, interleukin-1β, P-selection (or CD62P), basic fibroblast growth factor, lysophosphatidic acid, connective tissue growth factor, epithelial growth factor, hepatocyte growth factor, fibronectin, platelet-derived growth factor BB, transforming growth factor β1, vascular endothelial growth factor, insulin-like growth factor-1, pyrophosphate, and other cytokines and chemokines.

### BRIEF DESCRIPTION OF THE DRAWINGS

FIG. 1A is a plan view of a conventional membrane filtration apparatus in position with a loaded sample.

FIG. 1B is a plan view showing a conventional membrane filtration apparatus after centrifugation illustrating displacement of the sample into an inner tube.

FIG. 2A is a plan view showing the inner and outer tubes of a conventional filter membrane device.

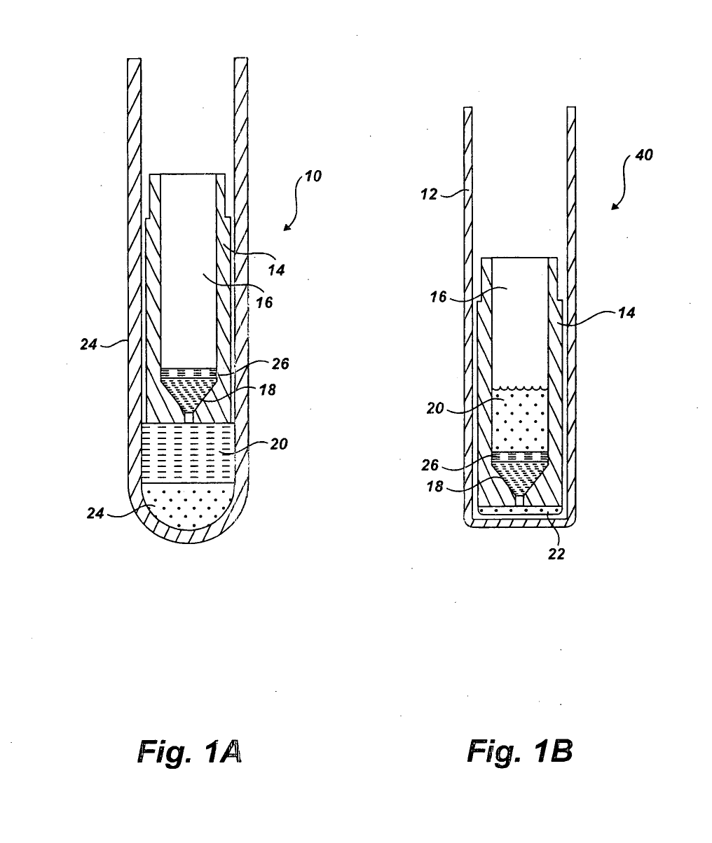

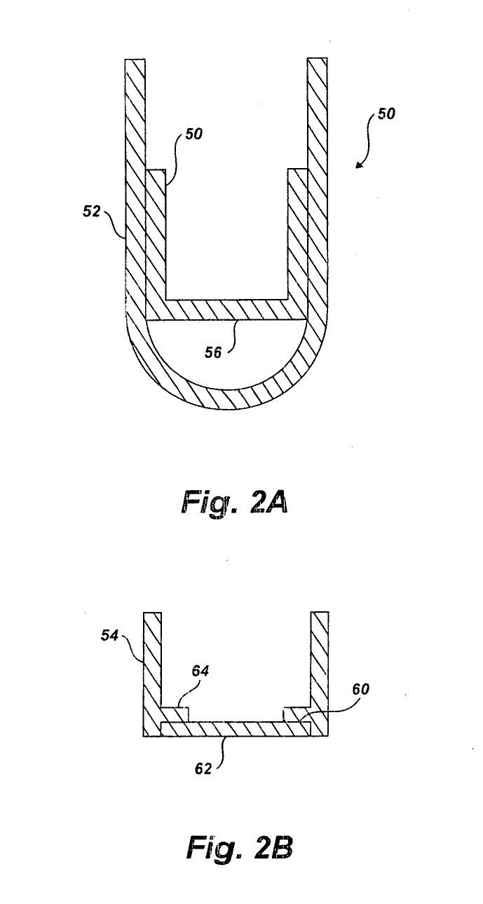

FIG. 1B is a cross-sectional plan view illustrating the placement of a filter membrane at the bottom of an inner tube in the filter membrane apparatus.

FIG. 3A is a graph of a standard curve for PPi in an assay for pyrophosphate.

FIG. 3B is a bar graph showing the levels of PPi comparing the method of the present invention with a conventional high speed centrifugation.

### DETAILED DESCRIPTION OF THE PREFERRED EMBODIMENTS

In the method of the present invention, a conventional membrane filtration apparatus for separating serum fractions by centrifugation is utilized to effect platelet removal from a plasma sample. One such apparatus is disclosed in U.S. Pat. No. 4,522,713, and representatively illustrated in FIGS. 1A and 1B hereof. FIG. 1A shows a filter apparatus, generally 10, having an outer tube 12 and an inner tube 14. The figure is shown with a quantity of plasma 20 in the bottom of the outer tube 12 and the inner tube 14 positioned to form a liquid engagement. A conical feed port 18 communicates with and is sealed to the bottom portion of the inner tube 14. FIG. 1B illustrates the position of the inner tube 14 and outer tube 12 after centrifugation. Note that liquid from the bottom 20 has been displaced into the cavity 16 of the inner tube 14 and forms a pool 20′. Note that the bottom of the outer tube 12 may be rounded 24 or square 22.

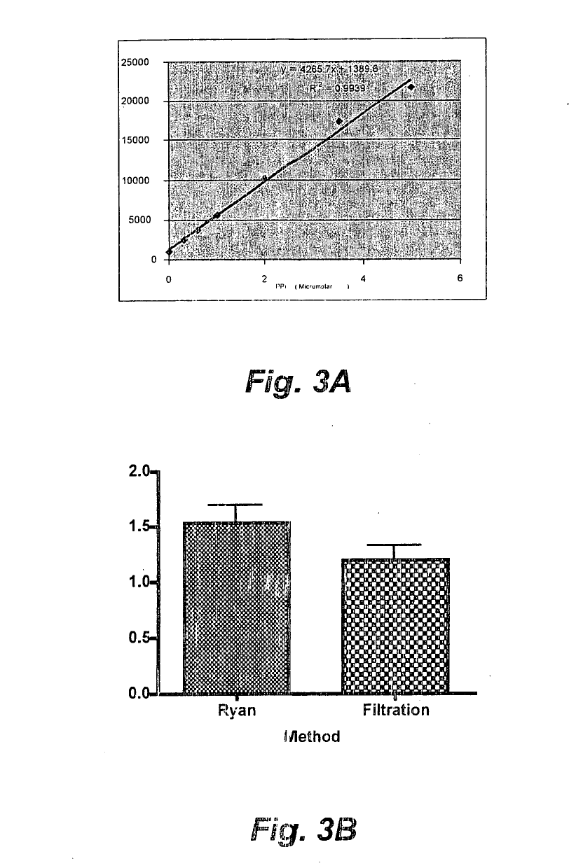

FIG. 2A depicts a centrifuge apparatus in its most generalized format. An inner tube 54 is inserted into an outer tube 52. The interface 58 between the outer tube 52 and inner tube 54 is snug to form a seal, but not so close a tolerance that the movement of the inner tube 54 is impeded during centrifugation. In one embodiment shown in FIG. 2B, a filter membrane 62 is inserted into a recess 60 having a depth equal to the thickness of the filter membrane 62. A lip 64 provides a seating surface for the filter membrane 62.

Several brands of the membrane filtration apparatus are available commercially. Sartorius manufactures and sells one such tube under the tradename Centrisart®, and most closely resembles the unit depicted in FIG. 2. Another similar apparatus is sold by Millipore under the Centricom® brand. Both companies provide filter membrane apparati containing membranes having a variety of pore sizes. Centrisart®, for example, has pore sizes with molecular weight exclusion limits of 5000 Da to 300000 Da. The apparatus is used to fractionate serum on the basis of size.

In the method of the present invention, plasma rather than serum is placed in the outer tube, the inner tube is inserted and the unit is centrifuged at low speed. “Low speed” means about 500 to 2500×g. Higher speeds may be used and will result in faster separation, as will larger pore sizes. All clinical laboratories will have the capability of centrifuging at low speeds, but high speed centrifugation is normally available only in research facilities. Use of the present method, thus enables all clinical laboratories to prepare platelet-free plasma, where the highest (45,000×g) level of platelet clearance is to be attained.

Platelet clearance using the apparatus of the present method is surprising in that filtration is not recommended in the literature for platelet separation. The reason for this is that platelets notoriously plug filters and do not permit pass-through of sufficient volume to perform assays. However, under conditions of centrifugation wherein filtration occurs by back-flow, the filter membrane appears to provide a barrier to diffusion of platelets. Sedimentation forces appear to counter balance the accumulation of sufficient platelets at the membrane surface to cause plugging. Further advantages to the present method will be apparent from the Example which follows.

### EXAMPLE

Applicant has chosen an assay for pyrophosphate since this is the most fastidious assay in the literature requiring platelet clearance. Also, pyrophosphate determination is becoming more important since pyrophosphate is associated with protection from vascular calcification associate with chronic kidney disease. If platelets are not removed substantially entirely, their presence will artificially inflate free pyrophosphate levels and lead to misdiagnosis.

Blood was collected from volunteers and processed using conventional methods. Platelet-free plasma was prepared by the method of the present invention using Centrisart® apparati (300,000 Da) according to the manufacturer's instructions, or by ultracentrifugation as taught by Ryan, et al., Arthritis and Rheumatism, 22: 886 (1979). Plasma pyrophosphate (PPi) was measured as described by Cheung, et al., Anal. Biochem, 83: 61 (1977) as modified by Lomashvili, et al., J. Am. Soc. Nephrol., 16:2495 (2005). A sample (20 μl) was added to 100 μl reaction mixture that contained 90 mM KC1, 5 mM MgCl₂, 70 mM Tris-HCl (pH 7.6), 10 μM NADPH, 3.7 μM uridine dephospho-glucose (UDPG), 0.25 U/ml UDPG pyrophospholase, 2.5 U/ml phosphoglucomutase, 0.5 U/ml glucose-6-phosphate dehydrogenase, and 0.15 μCi/ml [¹⁴C-UDPG. Standards of PPi were run in parallel (0.3-5.0 μM). After incubation for 60 minutes at room temperature, 200 μl of activated charcoal was added on ice with occasional stirring to bind residual UDPG. After centrifugation, the radioactivity in 200 μl of supernatant was counted. The standard curve for PPi is shown in FIG. 3A.

Comparison of results for the method of the invention and the Ryan method are shown in Table 1.

TABLE 1

| | |
|---|---|
| Ryan's Method | Applicant Method |

PPi (μM)

| | |
|---|---|
| 1.10 | 0.91 |
| 2.20 | 1.66 |
| 1.58 | 1.10 |
| 1.26 | 1.01 |

FIG. 3B is a bar graph showing the composite of values for the two methods. Note that the filtration values are significantly lower than those obtained from Ryan plasma. Applicant attributes this to the ability of the filter membrane to screen out platelet fragments which otherwise arise from high speed centrifugation.

What is claimed is:

1. A method for preparing a plasma specimen containing blood platelets for assay of an analyte comprising
introducing a quantity of a plasma test sample containing an analyte of interest into a centrifuge apparatus of a type having an inner substantially cylindrical tube with a bottom portion and an outer cylindrical tube said apparatus further characterized in having an analyte permeable membrane disposed between said inner and outer tube and mounted in said inner tube bottom portion
subjecting said plasma sample contained in said centrifuge apparatus to low speed centrifugation to separate platelet-free analyte solution in said inner tube; and
removing said separated analyte solution for assay.

2. The method of claim 1 wherein said analyte of interest is a substance partitioned between plasma in a free state and bound to or contained in platelets.

3. The method of claim 2 wherein an analyte of interest is selected from the group consisting of sphiningosine-1-phosphate, blood clotting factors, matrix metalloproteinase-2, nitric oxide, angiopoietin-2, interleukin-1β, P-selection, basic fibroblast growth factor, lysophosphatidic acid, connective tissue growth factor, epithelial growth factor fibronectin, serotonin, hepatocyte growth factor, platelet-derived growth factor BB, transforming growth factor β1, vascular endothelial growth factor, insultin-like growth factor-1, and pyrophosphate.

4. The method of claim 1 wherein said inner tube bottom portion in which a filter membrane is mounted, is substantially flat.
